(19) United States
(12) Patent Application Publication
(10) Pub. No.: US 2011/0157374 A1
(43) Pub. Date: Jun. 30, 2011

(54) Circuit for Calibrating Sync-on-Green Signal and Associated Method

(75) Inventors: Chih-Tien Chang, Hsinchu Hsien (TW); Tze Huei Kao, Hsinchu Hsien (TW); Da Wei Chiu, Hsinchu Hsien (TW)

(73) Assignee: MSTAR SEMICONDUCTOR, INC., Hsinchu Hsien (TW)

(21) Appl. No.: 12/978,068

(22) Filed: Dec. 23, 2010

(30) Foreign Application Priority Data
Dec. 25, 2009 (TW) 098145124

(51) Int. Cl. H04N 17/02

(52) U.S. Cl. 348/194; 348/E17.004

(57) ABSTRACT

A circuit for calibrating a sync-on-green (SOG) signal includes a switching device for controlling whether to output an image signal; a reference voltage generator for providing a clamp reference voltage and a comparison reference voltage; a clamp circuit for receiving the clamp reference voltage to generate a clamp output; and a comparing device for comparing the reference voltage with the clamp output to generate the SOG signal.

### CROSS REFERENCE TO RELATED PATENT APPLICATION

This patent application claims priority from Taiwan Patent Application No. 098145124 filed in the Taiwan Patent Office on Dec. 25, 2009, entitled “Circuit for Calibrating Sync-on-Green Signal and Associated Method”, and incorporates the Taiwan patent application in its entirety by reference.

### TECHNICAL FIELD

The present disclosure relates to synchronization of an image signal, and more particularly, to a circuit for calibrating a sync-on-green (SOG) signal and associated method.

### BACKGROUND OF THE PRESENT DISCLOSURE

Transmission and reception of an image data is achieved via good synchronous mechanism, and especially for high-resolution image. Accurate synchronous receiving control is needed for good image display quality. An SOG technique carries a synchronous signal sync on an SOG signal.

When the SOG signal is retrieved from an image signal by a conventional circuit, deformation of the retrieved SOG signal occurs due to unmatched circuit components, and thereby deteriorating the image display quality. In particular, since an offset voltage exists at an input end of an operational amplifier (op-amp), errors occur at an output end of the op-amp. In addition, the offset voltage of each chip circuit is different from the errors generated due to the offset voltage, but the conventional technique cannot calibrate the errors.

Since the conventional circuit cannot effectively calibrate the errors of the retrieved SOG signal, an SOG signal calibrating mechanism not undesirably affected by unmatched circuit components is needed.

### SUMMARY OF THE PRESENT DISCLOSURE

An object of the present disclosure is to provide a circuit and a method capable of calibrating errors due to unmatched circuit components or different wafers.

The present disclosure describes a circuit for calibrating an SOG signal comprises a switching device, a reference voltage generator, a comparing device and a clamp circuit. The switching device controls whether to output an image signal. The reference voltage generator provides a clamp reference voltage and a comparison reference voltage. The clamp circuit receives the clamp reference voltage to generate a clamp output. The comparing device compares the reference voltage with the clamp output to generate an output SOG signal. The clamp reference voltage and the comparison reference voltage are updated to find the transition of the output SOG signal.

The present disclosure further describes a method for calibrating an SOG signal comprises performing closed-loop clamping according to a predetermined reference voltage to generate a clamp output; comparing the clamp output with a comparison reference voltage to generate a comparison output; and recording a clamp parameter according to the comparison output. The clamp reference voltage and the comparison reference voltage are updated by sweeping a plurality of voltages according to the comparison output. Thus, a first intrinsic offset voltage and a second intrinsic offset voltage can be cancelled according to the clamp parameter.

### BRIEF DESCRIPTION OF THE DRAWINGS

FIG. 1 is a block diagram of a circuit for calibrating an SOG signal in accordance with an embodiment of the present disclosure.

FIG. 2 shows waveforms of an input SOG signal and an output SOG signal.

FIG. 3A is a detailed circuit for calibrating an SOG signal in accordance with an embodiment of the present disclosure.

FIG. 3B is a detailed circuit for calibrating an SOG signal in accordance with another embodiment of the present disclosure.

FIG. 4 is a flow chart of a method for calibrating an SOG signal in accordance with an embodiment of the present disclosure.

FIG. 5A and FIG. 5B show partial circuits of a reference voltage generator for configurations of switches during two periods.

### DETAILED DESCRIPTION OF THE PREFERRED EMBODIMENT

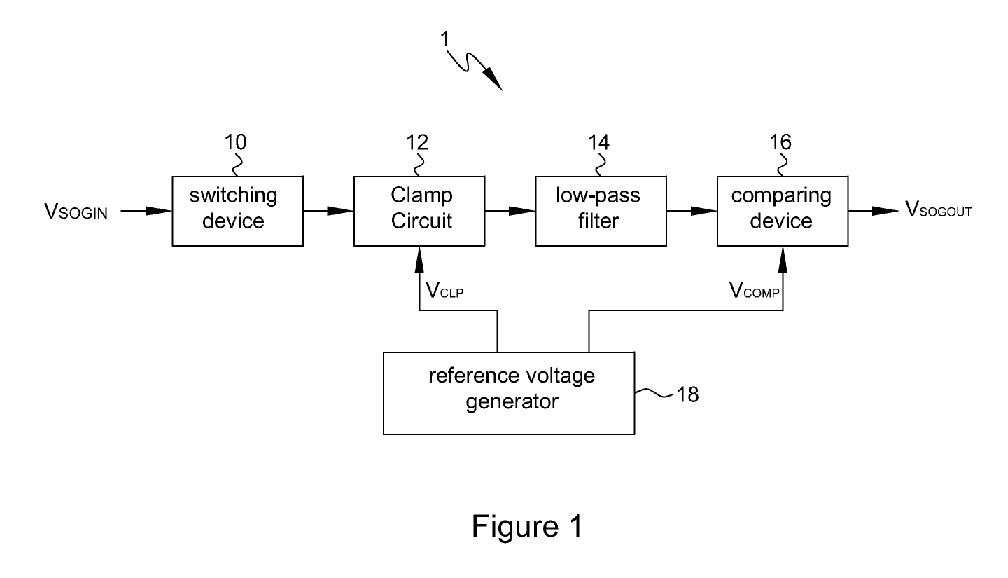

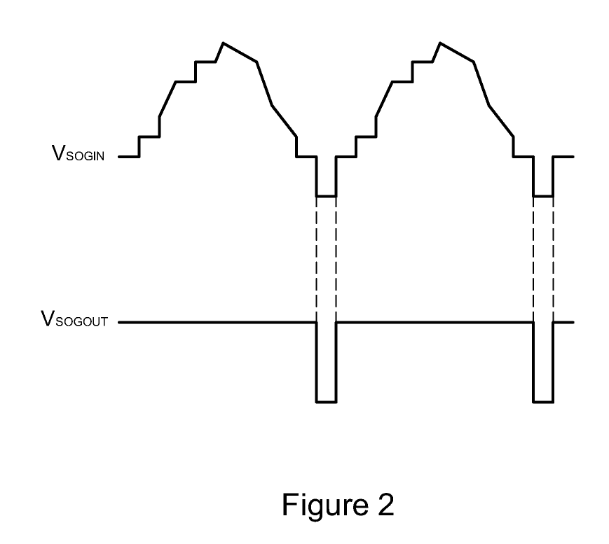

FIG. 1 shows a block diagram of a circuit 1 for calibrating an SOG signal in accordance with an embodiment of the present disclosure. The circuit 1 comprises a switching device 10, a clamp circuit 12, a low-pass filter 14, a comparing device 16, and a reference voltage generator 18. The switching device 10 controls whether to output an image signal. The clamp circuit 12 receives a predetermined reference voltage, e.g., a clamp reference voltage V_{CLP}, from the reference voltage generator 18, and generates a clamped output to the comparing device 16. The low-pass filter 14, coupled between the clamp circuit 12 and the comparing device 16, removes high-frequency (HF) noises from the clamped output of the clamp circuit 13. The low-pass filter 14 is optional. The comparing device 16 receives a comparison reference voltage V_{COMP} from the reference voltage generator 18 that is compared with the clamped output to generate an output SOG signal V_{SOGOUT}. FIG. 2 shows waveforms of an input SOG signal V_{SOGIN} and an output SOG signal V_{SOGOUT}.

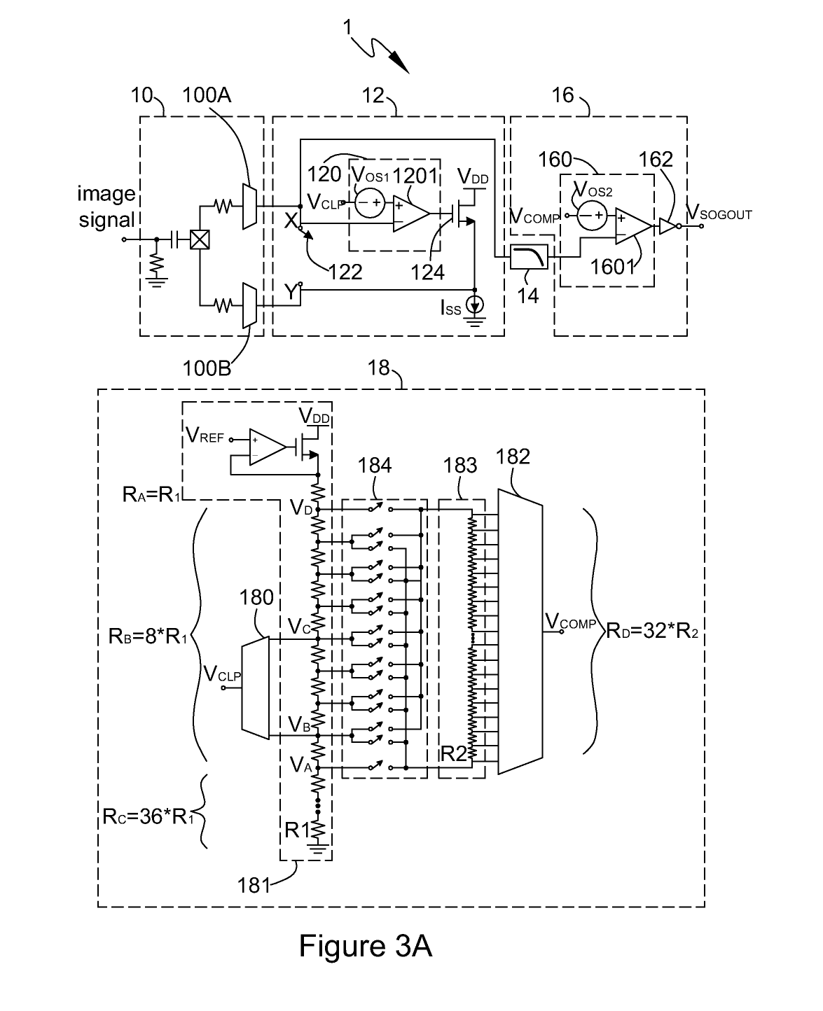

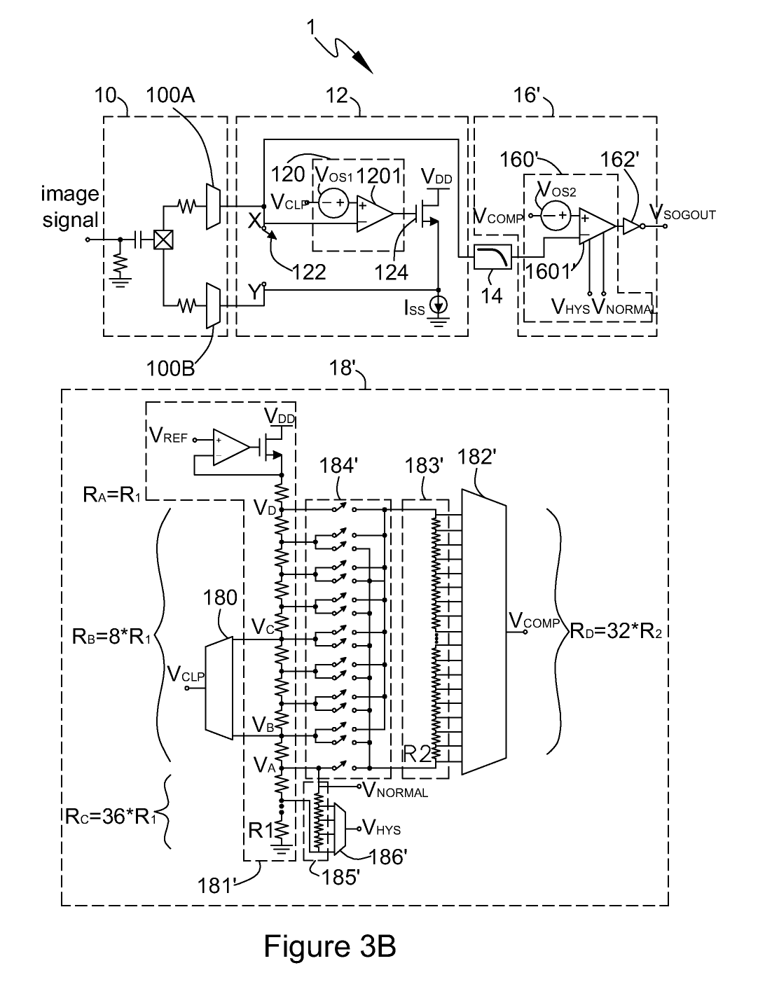

FIG. 3A is a detailed circuit 1 for calibrating an SOG signal in accordance with an embodiment of the present disclosure. The switching device 10 comprises one multiplexer 100A. Alternatively, for better effect, two multiplexers 100A and 100B coupled in parallel can be applied. For brevity, only one input end of each multiplexer is shown in FIG. 3A, and other input ends receive input SOG signals from other image sources. Upon selecting a desired image signal, the multiplexer 100A/100B outputs and feeds it to the clamp circuit 12. Once being disabled, the multiplexer 100A/100B stops all of the image signals, and presents high-impedance at its output end.

The clamp circuit 12 comprises a clamp op-amp 120, which is equivalent to an ideal op-amp 1201 and an intrinsic offset voltage source V_{OSI} coupled to a positive input end of the ideal op-amp 1201, and the clamp reference voltage V_{CLP} is received at another end of the offset voltage source V_{OSI} from the reference voltage generator 18. A negative input end of the clamp op-amp 120 is coupled to an output end of the multiplexer 100A, and is coupled to an output end of the clamp op-amp 120 via a switch 122 and a transistor 124, which is coupled between a voltage source V_{DD} and a current source I_{SS}.

The comparing device 16 comprises a comparison op-amp 160, which is equivalent to an ideal op-amp 1601 and an intrinsic offset voltage source V_{OS2} coupled to a positive input end of the ideal op-amp 1601, and a comparison reference voltage V_{COMP} is received at another end of the intrinsic offset voltage source V_{OS2} from the reference voltage generator 18. An output end of the op-amp 160 is coupled in series to an inverter 162, of which an output provides the output SOG signal V_{SOGOUT}. However, when connection configurations of the positive input end and the negative input end of the op-amp 160 are exchanged with each other, the inverter 162 can be omitted.

The reference voltage generator 18 comprises two voltage dividers 181 and 183. In FIG. 3A, a first voltage divider 181 comprises a plurality of first resistors R₁ serially-connected between the voltage source V_{DD} and ground. A partial resistor R_{B} provides a plurality of partial voltages from a first voltage V_{A} to a fourth voltage V_{D}, which are exemplified in FIG. 3A. The second voltage V_{B} and the third voltage V_{C} are selected by the first multiplexer 180 to generate the clamp reference voltage V_{CLP} to the clamp circuit 12. The second voltage divider 183 of the reference voltage generator 18 comprises a plurality of second resistors R₂ serially-connected, and the plurality of voltages are selected by the second multiplexer 182 to generate a comparison reference voltage V_{COMP} to the comparing device 16. Preferably, the resistance of the resistor R₂ is larger than that of the resistor R₁. In addition, a plurality of switches 184 coupled between the first voltage divider 181 and the second voltage divider 183 select a partial voltage of the first voltage divider 181, so that the partial voltage enters two ends of the second voltage divider and serves as a voltage source for the second voltage divider 183. In one embodiment, the first voltage V_{A}, the second voltage V_{B}, the third voltage V_{C} and the fourth voltage V_{D} are respectively 1.08V, 1.11V, 1.20V and 1.32V. The first voltage divider 181 applies a bandgap reference voltage of silicon. For example, when a constant reference voltage V_{REF} is 1.35V, the fourth voltage is 1.32V.

FIG. 3B shows a detailed circuit 1 for calibrating the SOG signal in accordance with another embodiment of the present disclosure. This embodiment is similar to the previous embodiment. In this embodiment, the comparing device 16′ applies a hysteresis comparator 160′, the reference voltage generator 18′ comprises a third voltage divider 185, and a hysteresis voltage V_{HYS} is provided to the hysteresis comparator 160′ via a third multiplexer 186′. The hysteresis comparator 160′ prevents the comparison result from being undesirably affected by noises to stabilize SOG signal V_{SOGOUT}.

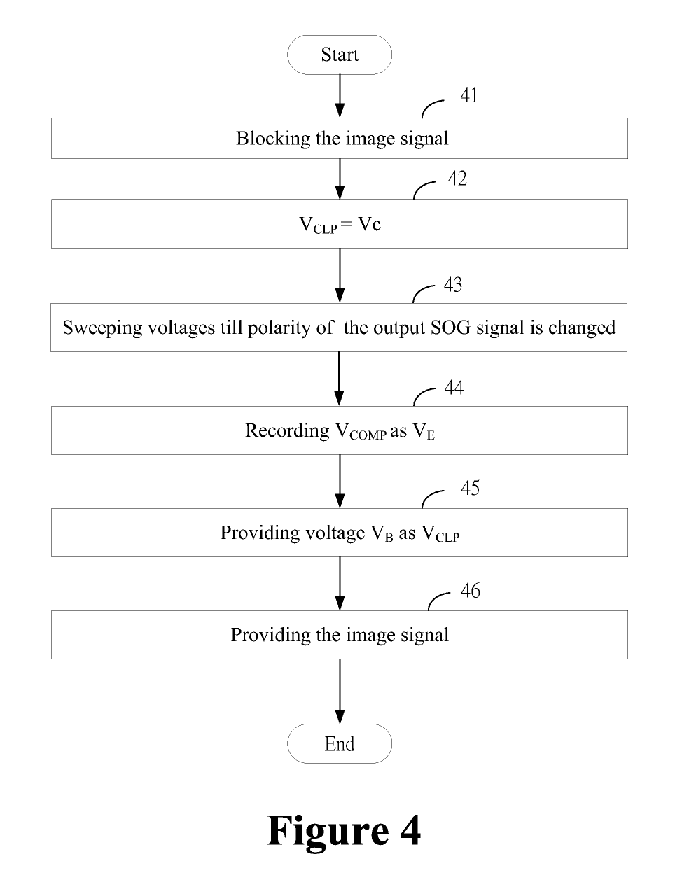

FIG. 4 shows a flow chart of a method for calibrating an SOG signal in accordance with an embodiment of the present disclosure. Please refer to FIG. 4 together with FIG. 3A or FIG. 3B. In Step 41, the image signal is blocked by disabling the multiplexer 100A/100B, and nodes X and Y are conducted by closing a switch 122. After the switch 122 is closed, the clamp op-amp 120 of the clamp circuit 12 forms a feedback configuration and enters a calibration mode.

In Step 42, the first multiplexer 180 of the reference voltage generator 18 selects the third voltage V_{C} (e.g., 1.20V) to the clamp circuit 12 that serves as the clamp reference voltage V_{CLP}. Preferably, the third voltage V_{C} is selected as a predetermined value or a target value of the comparison reference voltage V_{COMP}. The clamp circuit 12 feeds a clamp output generated at the node X to the comparing device 16.

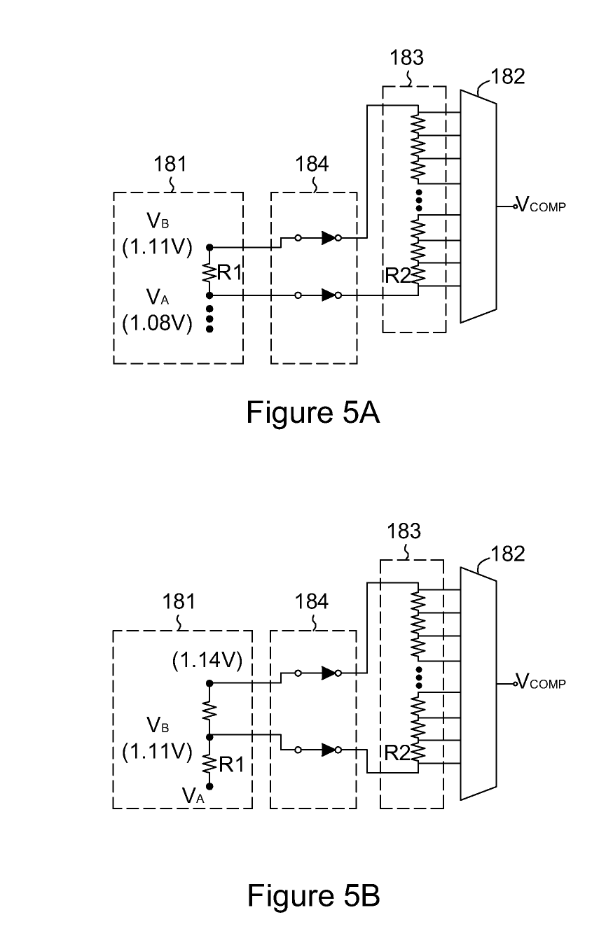

In Step 43, the second multiplexer 182 of the reference voltage generator 18 selects different voltages between the first voltage V_{A} and the fourth voltage V_{D} (e.g., between 1.08V and 1.32V) to the comparing device 16 as the comparison reference voltage V_{COMP}. For example, voltages between the first voltage V_{A} and the fourth voltage V_{D} are swept. According to configurations of the switches 184 of the reference voltage generator 18, different comparison reference voltages V_{COMP} can be provided accurately. FIG. 5A and FIG. 5B show a partial circuit of the reference voltage generator 18 to illustrate different configurations of the switches 184 during two periods. In FIG. 5A, the second multiplexer 182 sweeps voltages between the first voltage V_{A} and the second voltage V_{B}, e.g. between 1.08V and 1.11V, to the comparing device 16. In FIG. 5B, the second multiplexer 182 sweeps voltages, e.g. between 1.11V and 1.14V, to the comparing device 16.

The comparing device 16 compares the clamp output with the swept comparison reference voltages to generate a comparison output. The voltages are continuously swept till polarity of the output end (i.e., the output SOG signal V_{SOGOUT}) of the inverter 162 of the comparing device 16 is changed, e.g. the output SOG signal V_{SOGOUT} in FIG. 2 is changed from a positive level to a negative level. Supposing that a sweep value is V_{E} when the polarity is changed, at this point, a voltage at the positive input end of the op-amp 160 equals that at the negative input end, i.e., V_{OS2}+V_{E}=V_{OS1}+V_{C}. Accordingly, it is determined that:

V_{COMP}=V_{E}=V_{C}+V_{OS1}−V_{OS2}.

In Step 44, a clamp parameter is recorded according to the comparison output, i.e., a code value of V_{E} is recorded for normal operation. In Step 45, the first multiplexer 180 of the reference voltage generator 18 selects the second voltage V_{B}, e.g., 1.11V, to the clamp circuit 12, such that the clamp reference voltage V_{CLP} is changed from the original third voltage V_{C}, e.g., 1.20V, to the second voltage V_{B}, e.g., 1.11V. After that, the switch 122 is closed to form a short circuit between the node X and the node Y. Accordingly, the calibration procedure of a clamp level of the SOG signal is completed, and a detection procedure of the SOG signal begins. According to the foregoing calibration procedure, when the comparison reference voltage V_{COMP}=V_{E} and V_{COMP}=V_{B}, a voltage difference between the positive input end and the negative input end is determined that:

$$V ( positive input end ) - V ( negative input end ) = \{ {V}_{OS 2} + ( {V}_{C} + {V}_{OS 1} - {V}_{OS 2} ) \} - \{ ( {V}_{B} + {V}_{OS 1} ) \} = {V}_{C} - {V}_{B} .$$

Accordingly, the voltage difference, i.e., V_{C}−V_{B}, between the positive input end and the negative input end of the comparison op-amp 160 is not affected by the intrinsic offset voltage source V_{OS1} or V_{OS2}. In other words, the offset voltage sources V_{OS1} and V_{OS2} are cancelled so that no undesirable influences occur in the detection procedure of the SOG signal.

In Step 46, the multiplexer 100A/100B is enabled to output the image signal to the clamp circuit 12 and the detection procedure of the SOG signal begins.

To sum up, the present disclosure describes a circuit for calibrating an SOG signal comprises a switching device, a reference voltage generator, a comparing device and a clamp circuit. The switching device controls whether to output an image signal. The reference voltage generator provides a clamp reference voltage and a comparison reference voltage. The clamp circuit receives the clamp reference voltage to generate a clamp output. The comparing device compares the reference voltage with the clamp output to generate an output SOG signal. The clamp reference voltage and the comparison reference voltage are updated to find the transition of the output SOG signal.

The present disclosure further describes a method for calibrating an SOG signal comprises performing closed-loop clamping according to a predetermined reference voltage to generate a clamp output; comparing the clamp output with a comparison reference voltage to generate a comparison output; and recording a clamp parameter according to the comparison output. The clamp reference voltage and the comparison reference voltage are updated by sweeping a plurality of voltages according to the comparison output. Thus, a first intrinsic offset voltage and a second intrinsic offset voltage can be cancelled according to the clamp parameter.

While the present disclosure has been described in terms of what is presently considered to be the most practical and preferred embodiments, it is to be understood that the present disclosure needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A circuit for calibrating a sync-on-green (SOG) signal, comprising:
a switching device that controls whether to output an image signal;
a reference voltage generator that generates a clamp reference voltage and a comparison reference voltage;
a clamp circuit that receives the clamp reference voltage to generate a clamp output; and
a comparing device that compares the comparison reference voltage with the clamp output to generate an output SOG signal.

2. The circuit as recited in claim 1, wherein the reference voltage generator updates a level of the comparison reference voltage.

3. The circuit as recited in claim 2, wherein the reference voltage generator changes the clamp reference voltage in response to a change in a polarity of the output SOG signal.

4. The circuit as recited in claim 1, further comprising a low-pass filter, electrically connected between the clamp circuit and the comparing device, that filters out high-frequency noises in the clamp output.

5. The circuit as recited in claim 1, wherein the switching device comprises a multiplexer, and when the multiplexer is disabled, the image signal is blocked and high-impedance is present at an output end of the multiplexer.

6. The circuit as recited in claim 5, wherein the multiplexer is disabled when a calibration procedure is performed, and the multiplexer is enabled when the procedure ends.

7. The circuit as recited in claim 1, wherein the clamp circuit comprises an operational amplifier (op-amp) having a positive input end that receives the clamp reference voltage, a negative end served as an output end of the switching device, and an output end, with the negative end being coupled to the output end of the op-amp via a switch.

8. The circuit as recited in claim 7, wherein the switch is closed when a calibration procedure is performed, and the switch opens when the calibration procedure ends.

9. The circuit as recited in claim 1, wherein the comparing device comprises a comparison operational amplifier (op-amp) having a positive input end that receives the comparison reference voltage, and a negative input end that directly or indirectly receives the clamp output.

10. The circuit as recited in claim 9, wherein the comparing device further comprises an inverter having an input end served as the output end of the comparison op-amp.

11. The circuit as recited in claim 1, wherein the reference voltage generator comprises:
a first voltage divider, comprising a plurality of first resistors coupled in series, that provide a first voltage, a second voltage, a third voltage, and a fourth voltage, with the second voltage and the third voltage being between the first voltage and the fourth voltage;
a second voltage divider, comprising a plurality of second resistors coupled in series;
a first multiplexer that selects the second voltage or the third voltage as the clamp reference voltage;
a plurality of switches that directs a partial voltage generated by the first voltage divider to two ends of the second voltage divider; and
a second multiplexer that selects one of a plurality of voltages generated by the second voltage divider as the comparison reference voltage.

12. The circuit as recited in claim 11, wherein the first voltage divider generates the first voltage, the second voltage, the third voltage, and the fourth voltage utilizing a bandgap voltage.

13. The circuit as recited in claim 11, wherein the comparing device comprises a hysteresis comparator, and the reference voltage generator comprises a third voltage divider that provides a hysteresis voltage to the hysteresis comparator.

14. A method for calibrating an SOG signal, comprising:
performing a closed-loop clamping according to a predetermined reference voltage to generate a clamp output;
comparing the clamp output with a comparison reference voltage to generate a comparison output; and
recording a clamp parameter according to the comparison output;
wherein, a first intrinsic offset voltage and a second intrinsic offset voltage are cancelled according to the clamp parameter.

15. The method as recited in claim 14, further comprising blocking an image signal before generating the clamp output.

16. The method as recited in claim 15, further comprising providing the image signal after recording the clamp parameter.

17. The method as recited in claim 14, wherein the predetermined reference voltage is a clamp reference voltage.

18. The method as recited in claim 14, further comprising updating the predetermined reference voltage.

19. The method as recited in claim 14, further comprising updating the comparison reference voltage.

20. The method as recited in claim 14, further comprising updating the clamp reference voltage and the comparison reference voltage by sweeping a plurality of voltages according to the comparison output.
